(19) United States
(12) Patent Application Publication
(10) Pub. No.: US 2015/0248741 A1
(43) Pub. Date: Sep. 3, 2015

(54) SYSTEM AND METHOD FOR PROVIDING POWER-SAVING STATIC IMAGE DISPLAY REFRESH IN A DRAM MEMORY SYSTEM

(71) Applicant: QUALCOMM INCORPORATED, SAN DIEGO, CA (US)

(72) Inventors: ALI IRANLI, SAN DIEGO, CA (US); MOINUL H. KHAN, SAN DIEGO, CA (US); HAW-JING LO, SAN DIEGO, CA (US)

(73) Assignee: QUALCOMM INCORPORATED, SAN DIEGO, CA (US)

(21) Appl. No.: 14/194,743

(22) Filed: Mar. 2, 2014

(51) Int. Cl. G06T 1/60

(52) U.S. Cl. CPC G06T 1/60; G09G 2330/022

(57) ABSTRACT

Systems, methods, and computer programs are disclosed for reducing power consumption for static image display refresh in a dynamic random access memory (DRAM) memory system. One such method comprises: prefetching static image frame content from a DRAM memory device into a system cache; during a static display refresh operation, a display processor reads the static image frame content from the system cache while the DRAM memory device is in a power-saving, self-refresh state; and the display processor feeding the static image frame content to a mobile display.

### DESCRIPTION OF THE RELATED ART

With the widespread commercial adoption of portable computing devices, such as, cellular telephones, smart phones, tablet computers, portable digital assistants (PDAs), and portable game consoles, it is becoming more commonplace to offer such devices with larger display sizes and higher resolution displays. Higher-resolution display panels typically do not have an integrated frame buffer. In such devices, the display panel content is refreshed (or fed to the display) every 60 frames a second, even if the screen content is not changing (e.g., a user reading a news website for an extended period of time). Screen content that remains unchanged, yet continues to be refreshed, is generally referred to as static image frame content.

In many portable computing devices, the static image frame content is stored in a memory subsystem (e.g., dynamic random access memory (DRAM)). The DRAM may be coupled to, for example, a System on Chip (SoC) that houses various system components (e.g., memory clients, a mobile display processor, a DRAM memory controller, and a system cache, among other components). During static image display, the frame content is stored in DRAM, such as, double data rate (DDR) memory. The mobile display controller or processor reads the pixel data and feeds it to the display panel. Static display refresh power is a key contributor to the amount of time such devices can be used on a single battery charge, as well as for browser power competitiveness. The key contributor to the power for static image display refresh comes from the DDR power.

Accordingly, there remains a need in the art for improved systems and methods for reducing the consumption of power during static image display refresh in computing devices that employ these and other types and configurations of memory devices.

### SUMMARY OF THE DISCLOSURE

Systems, methods, and computer programs are disclosed for reducing power consumption for static image display refresh in a DRAM memory system. One such method comprises: prefetching static image frame content from a DRAM memory device into a system cache; during a static display refresh operation, a display processor reading the static image frame content from the system cache while the DRAM memory device is in a power-saving, self-refresh state; and the display processor feeding the static image frame content to a mobile display.

Another embodiment is system for reducing power consumption for static image display refresh. The system comprises a system on chip, a volatile memory device, and a power-saving static display refresh module. The SoC comprises a system cache, a display processor, and a memory controller. The volatile memory device resides off-chip and is coupled to the memory controller. The power-saving static display refresh module comprises logic configured to: prefetch static image frame content from the volatile memory device into a system cache; during a static display refresh operation, read the static image frame content from the system cache while the volatile memory device is in a power-saving, self-refresh state; and feed the static image frame content to a mobile display.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for reducing power consumption for static image display refresh.

FIG. 2 is a combined block/flow diagram illustrating the operation of an embodiment of a power-saving static display refresh method in the system of FIG. 1.

FIG. 3 is a flowchart illustrating an embodiment of the architecture, operation, and/or functionality of the power-saving static display refresh module(s) in the system of FIG. 1.

FIG. 4 is a series of timing diagrams illustrating a burst prefetch into the system cache.

FIG. 5 is a combined block/flow diagram illustrating the operation of another embodiment of the power-saving static display refresh method in the system of FIG. 1.

FIG. 6 is a block diagram of an embodiment of a portable computer device comprising the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

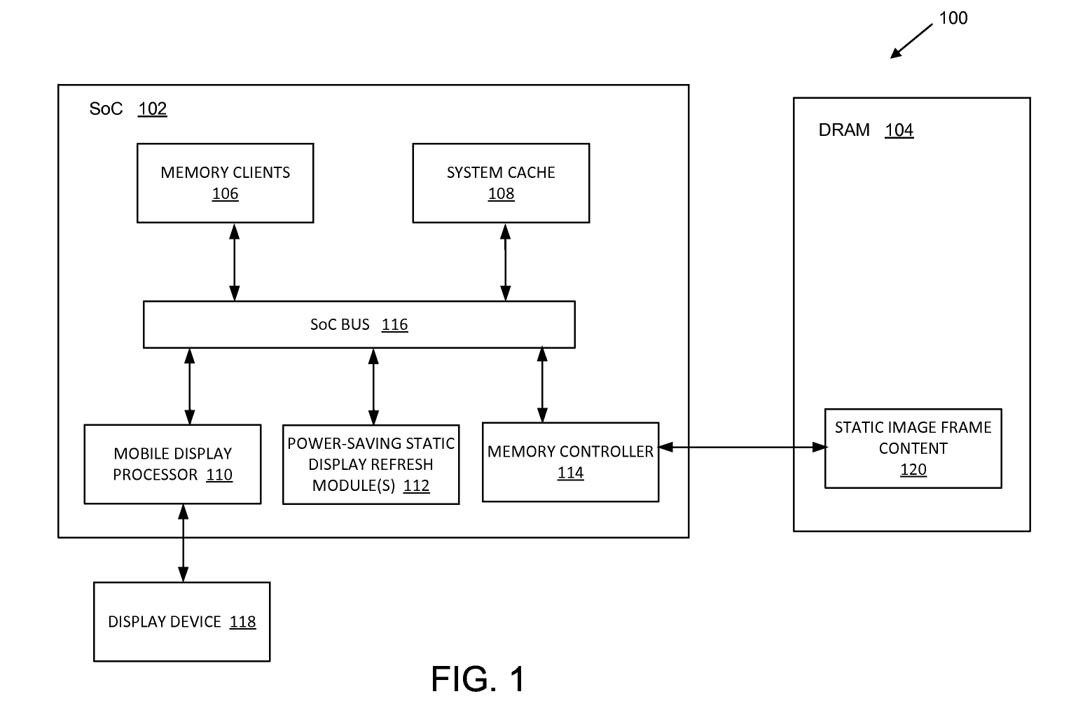

FIG. 1 illustrates a system 100 for reducing power consumption for static image display refresh in a DRAM memory system. The system 100 may be implemented in any computing device, including a personal computer, a workstation, a server, a portable computing device (PCD), such as a cellular telephone, a portable digital assistant (PDA), a portable game console, a palmtop computer, or a tablet computer. As illustrated in the embodiment of FIG. 1, the system 100 comprises a system on chip (SoC) 102 coupled to a memory system comprising DRAM 104. The SoC 102 comprises various on-chip components, including one or more memory clients 106 that request memory resources from DRAM 104. The memory clients 106 may comprise one or more processing units (e.g., central processing unit (CPU), graphics processing unit (GPU), digital signal processor (DSP), mobile display processor 106, etc.), a video encoder, or other clients requesting read/write access to DRAM 104. The memory clients 106, a system cache 108, mobile display processor 110, and memory controller 114 may be interconnected via a SoC bus 116. The mobile display processor 110 acquires, processes, and feeds display data (including static image frame content 120) to the display device 118.

As further illustrated in FIG. 1, the system 100 comprises power-saving static display refresh module(s) 112, which generally comprise the logic for reducing power consumption during static image display refresh of static image frame content 120 using the system cache 108. One or more aspects of power-saving static display refresh module(s) 112 may be integrated in mobile display processor 110, memory controller 114, system cache 108, or other components.

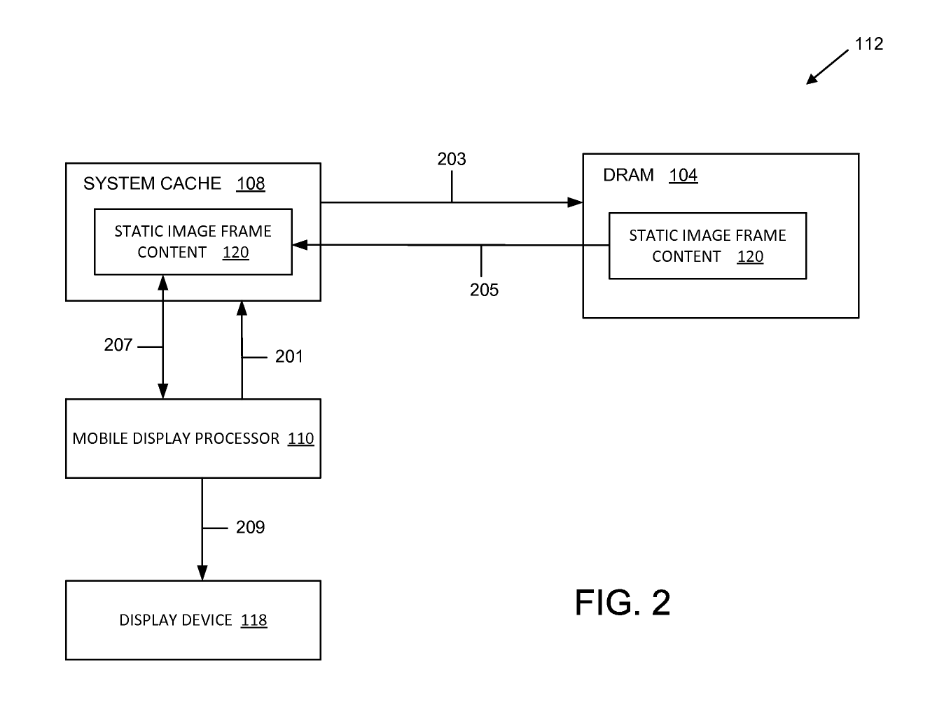

FIG. 2 illustrates one exemplary implementation of a method for reducing power consumption during static image display refresh using system cache 108. In an embodiment, system cache 108 comprises a system-level cache used by, for example, a central processing unit (CPU) to reduce the average time to access memory. The system cache 108 may comprise one or more of a plurality of independent CPU or other caches organized as a hierarchy of cache levels (e.g., L1, L2, L3, etc.). In operation, the mobile display processor 110 may initiate static image display refresh. The mobile display processor 110 may issue one or more prefetches of the static image frame content 120 stored in DRAM 104 into the system cache 108. The mobile display processor 110 may issue a prefetch command (arrow 201) to the system cache 108. As described below in more detail, the prefetch command may include data defining a variable burst length for prefetching the static image frame content 120 from DRAM 104 into the system cache 108. At arrow 203, the system cache 108 (or an associated memory controller 114) sends a request to DRAM 104 to prefetch the static image frame content 120. It should be appreciated that the static image frame content 120 (or a portion thereof) may be prefetched in a burst mode defined by a prefetch burst length (BL) at a relatively higher bandwidth (e.g., Gigabytes/sec). At arrow 205, the static image frame content 120 is stored in the system cache 108. During static image refresh, the mobile display processor 110 may read pixel data from the system cache 108 (arrow 207). It should be appreciated that the mobile display processor 110 may read-out the prefetched static image frame content 120, from the system cache 108, at a read burst length (BL) that is less than the prefetch burst length and at a relatively lower bandwidth (e.g., Megabytes/sec).

While the mobile display processor 110 is reading refresh data from the system cache 108, the DRAM 104 and associated components may be placed in a power-saving, self-refresh state. For example, in an embodiment, the memory controller 114 may be turned off and/or the DRAM 104 may be placed in a self-refresh state to reduce power consumption during static image refresh. At arrow 209, the mobile display processor 110 may feed the refresh data to the display device 118.

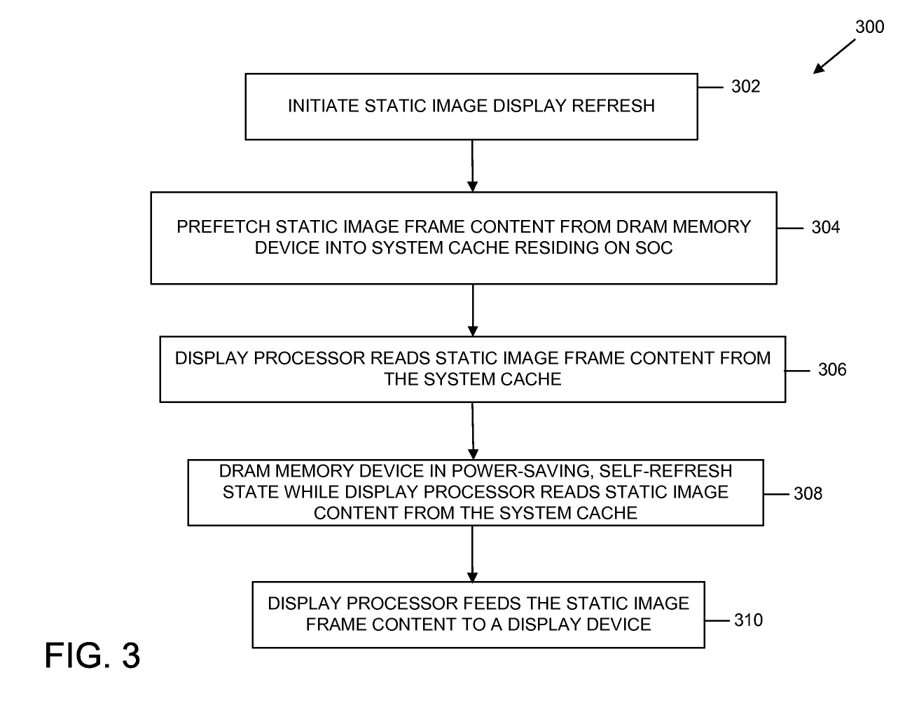

FIG. 3 illustrates an embodiment of a method 300 implemented in the system 100 for reducing power consumption during static image display refresh. At block 302, static image display refresh may be initiated by, for example, the mobile display processor 110 or other components in system 100. At block 304, the static image frame content stored in DRAM memory 104 may be prefetched into system cache 108. The mobile display processor 108 may issue one or more prefetches into system cache 108. In an embodiment, the mobile display processor 108 may send prefetch commands or “hints” to system cache 108. As mentioned above, the prefetch command(s) may define a prefetch burst length based on the available bandwidth. During static image display refresh, at block 306, the mobile display processor 108 may start issuing read transactions for screen refresh through system cache 108 instead of through DRAM 104. While the mobile display processor 108 is reading the static image frame content 120 from system cache 108, at block 308, the DRAM 104 may be placed in a power-saving, self-refresh state. It should be appreciate that additional power savings may be yielded by turning off other unnecessary power-consuming components, such as, for example memory controller 114. At block 310, the mobile display processor 118 feeds the static image frame content 120 to the display device 118.

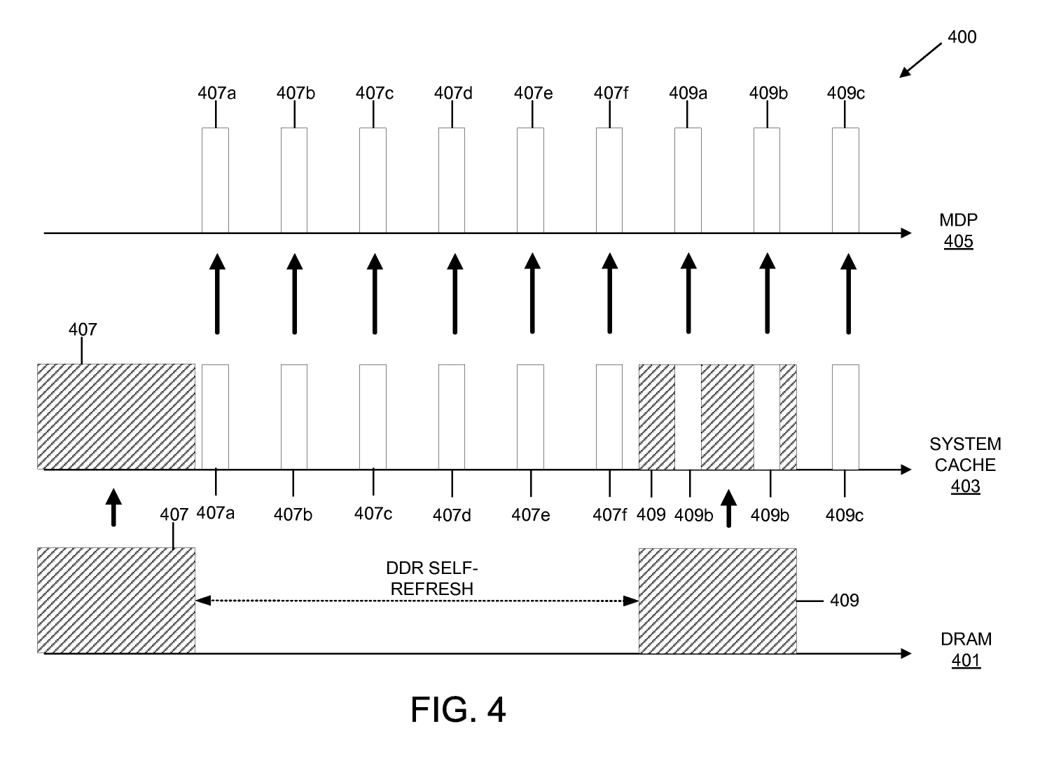

FIG. 4 illustrates timing diagrams associated with the DRAM 104 (DRAM timeline 401), the system cache 108 (system cache timeline 403), and the mobile display processor 110 (MDP timeline 405) during the power-saving static display refresh performed by the system 100. As shown in DRAM timeline 401, the static image frame content 120 stored in DRAM 104 may be prefetched into system cache 108 at a predefined or variable burst length based on the available bandwidth. Blocks 407 and 409 represent portions of the static image frame content 120 that are prefetched into the system cache 108. The width of blocks 407 and 409 define the corresponding burst length.

Referring to FIG. 4, a first block 407 may be prefetched into system cache 108 at a first time. The first block 407 may then be read-out of the system cache 108 by the mobile display processor 110 in smaller-sized chunks of data (i.e., blocks 407a-407f) at a slower bandwidth. It should be appreciated that prefetching into system cache 108 may occur at a relatively higher bandwidth (e.g., Gigabytes/sec) than the bandwidth at which the mobile display processor 108 reads the data from system cache 108 (e.g., Megabytes/sec). In this regard, the prefetched data contained in first block 407 may be divided into smaller data blocks 407a, 407b, 407c, 407d, 407e, and 407f. During static image display refresh, the mobile display processor 108 reads out each of blocks 407a-407f at the relatively lower bandwidth. While blocks 407a-407f are being read from system cache 108, DRAM 104 may be placed in the power-saving, self-refresh state as described above.

After blocks 407a-407f are read from system cache 108 by mobile display processor 110 (or otherwise after first block 407 is prefetched), the second block 409 may be prefetched into system cache 108. In an embodiment, the time between prefetched blocks 407 and 409 may be based on the DDR self-refresh rate. The prefetched data contained in second block 409 may be similarly divided into smaller blocks 409a-409f (note only blocks 409a-409c are illustrated for simplicity). During continued static image display refresh, the mobile display processor 108 reads out each of blocks 409a-409f while DRAM 104 may be placed in the power-saving, self-refresh state.

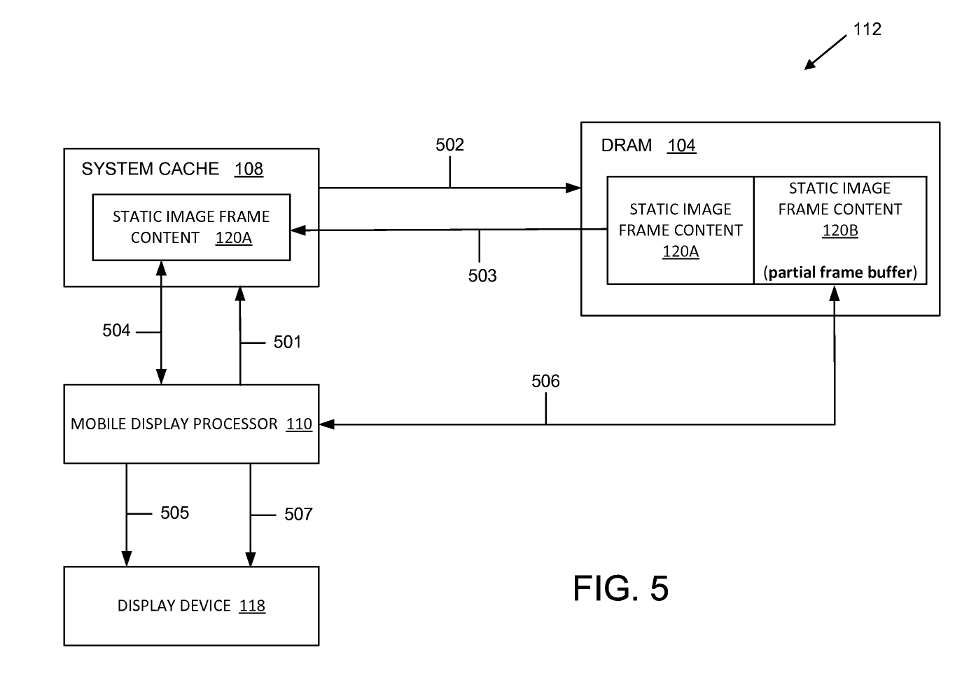

FIG. 5 illustrates another exemplary implementation of a method for reducing power consumption during static image display refresh using system cache 108. In this embodiment, a portion of the static image frame content 120a is prefetched into system cache 108 and refreshed by mobile display processor 108 from system cache 108. A remaining portion of the static image frame content 120b is read from DRAM 104. This partial frame buffer embodiment may be implemented in situations in which the size of available memory in system cache 108 is not large enough for the frame buffer. In this approach, the DRAM 104 is placed in the power-saving, self-refresh state while the mobile display processor 108 is reading from system cache 108.

Referring to FIG. 5, the mobile display processor 110 may issue one or more prefetches of the static image frame content 120a stored in DRAM 104 into the system cache 108. The mobile display processor 110 may issue a prefetch command (arrow 501) to the system cache 108. At arrow 502, the system cache 108 (or an associated memory controller 114) sends a request to DRAM 104 to prefetch the portion 120a of static image frame content 120 based on the available memory in system cache 108. At arrow 503, the portion 120a of static image frame content 120 is stored in the system cache 108. The mobile display processor 110 may read portion 120a from the system cache 108 (arrow 504) and feed it to display device 118 (arrow 505). While the mobile display processor 110 is reading portion 120a from the system cache 108, the DRAM 104 and associated components may be placed in a power-saving, self-refresh state. The remaining portion 120b of static image frame content 120 may be read by mobile display processor 108 from DRAM 104 (arrow 506) and fed to display device 118 (arrow 507).

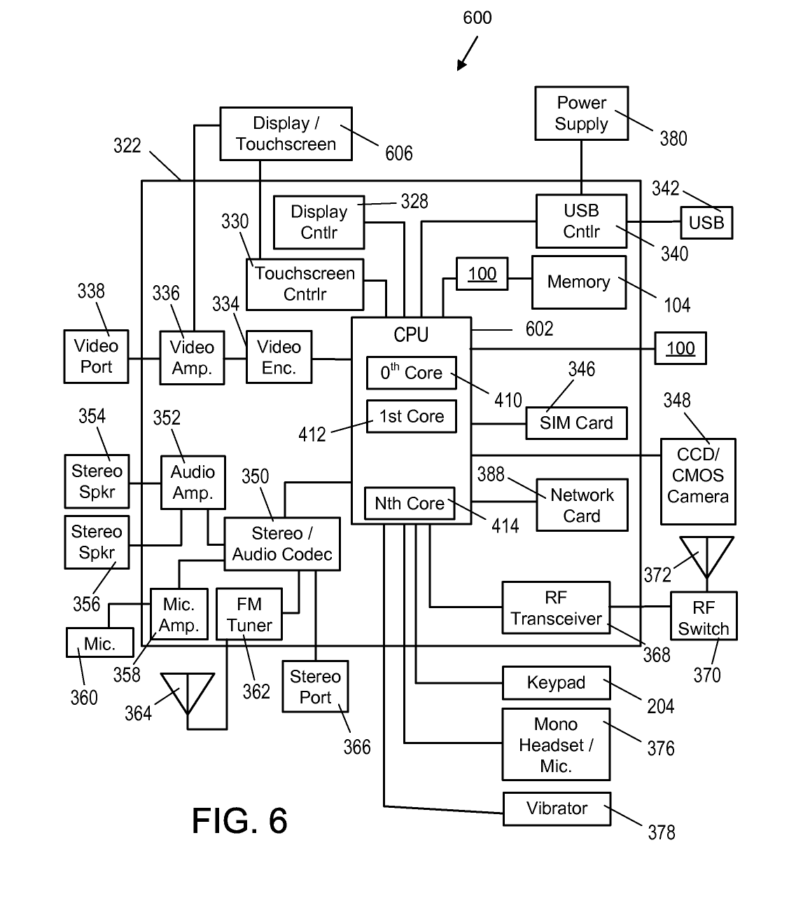

As mentioned above, the system 100 may be incorporated into any desirable computing system. FIG. 6 illustrates the system 100 incorporated in an exemplary portable computing device (PCD) 600. It will be readily appreciated that certain components of the system 100 are included on the SoC 322 (FIG. 6) while other components (e.g., the DRAM 104) are external components coupled to the SoC 322. The SoC 322 may include a multicore CPU 602. The multicore CPU 602 may include a zeroth core 410, a first core 412, and an Nth core 414. One of the cores may comprise, for example, a graphics processing unit (GPU) with one or more of the others comprising the CPU.

A display controller 328 and a touch screen controller 330 may be coupled to the CPU 602. In turn, the touch screen display 108 external to the on-chip system 322 may be coupled to the display controller 328 and the touch screen controller 330.

FIG. 6 further shows that a video encoder 334, e.g., a phase alternating line (PAL) encoder, a sequential color a memoire (SECAM) encoder, or a national television system(s) committee (NTSC) encoder, is coupled to the multicore CPU 602. Further, a video amplifier 336 is coupled to the video encoder 334 and the touch screen display 606. Also, a video port 338 is coupled to the video amplifier 336. As shown in FIG. 6, a universal serial bus (USB) controller 340 is coupled to the multicore CPU 602. Also, a USB port 342 is coupled to the USB controller 340. Memory 104 and a subscriber identity module (SIM) card 346 may also be coupled to the multicore CPU 602. Memory 104 may reside on the SoC 322 or be coupled to the SoC 322 (as illustrated in FIG. 1). The memory 104 may comprise a DRAM memory system (FIG. 1) as described above.

Further, as shown in FIG. 6, a digital camera 348 may be coupled to the multicore CPU 602. In an exemplary aspect, the digital camera 348 is a charge-coupled device (CCD) camera or a complementary metal-oxide semiconductor (CMOS) camera.

As further illustrated in FIG. 6, a stereo audio coder-decoder (CODEC) 350 may be coupled to the multicore CPU 602. Moreover, an audio amplifier 352 may coupled to the stereo audio CODEC 350. In an exemplary aspect, a first stereo speaker 354 and a second stereo speaker 356 are coupled to the audio amplifier 352. FIG. 6 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 6 further illustrates that a radio frequency (RF) transceiver 368 may be coupled to the multicore CPU 602. An RF switch 370 may be coupled to the RF transceiver 368 and an RF antenna 372. A keypad 204 may be coupled to the multicore CPU 602. Also, a mono headset with a microphone 376 may be coupled to the multicore CPU 602. Further, a vibrator device 378 may be coupled to the multicore CPU 602.

FIG. 6 also shows that a power supply 380 may be coupled to the on-chip system 322. In a particular aspect, the power supply 380 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 6, the touch screen display 606, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for reducing power consumption for static image display refresh, the method comprising:
prefetching static image frame content from a dynamic random access memory (DRAM) memory device into a system cache;
during a static display refresh operation, reading the static image frame content from the system cache with a display processor while the DRAM memory device is in a power-saving, self-refresh state; and
the display processor feeding the static image frame content to a mobile display.

2. The method of claim 1, wherein the power-saving, self-refresh state comprises turning off the DRAM memory device and a memory controller.

3. The method of claim 1, wherein the prefetching the static image frame content from the DRAM memory device into the system cache comprises the display processor sending a prefetch command to a system cache controller.

4. The method of claim 3, wherein the prefetch command comprises a variable burst length.

5. The method of claim 1, wherein the static image frame content is prefetched from the DRAM memory device into the system cache at a first burst length and the display processor reads the static image frame content from the system cache at a second burst length, wherein the first burst length is longer than the second burst length.

6. The method of claim 1, wherein the DRAM memory device comprises a double data rate (DDR) memory device and the static image frame content is prefetched from the DRAM memory device into the system cache at a double data rate (DDR) self-refresh rate.

7. The method of claim 1, wherein the display processor and the system cache reside on a system on chip (SoC) and the DRAM memory device is off-chip and connected to the SoC via a memory controller.

8. The method of claim 1, wherein a portion of the static image frame content is prefetched from the DRAM memory device and loaded into and read from the system cache, and the remaining portion of the static image frame content is read from the DRAM memory device, and wherein the DRAM memory device is placed in the power-saving, self-refresh state while the portion of the static image frame content is read from the system cache.

9. A system for reducing power consumption for static image display refresh, the method comprising:
means for prefetching static image frame content from a dynamic random access memory (DRAM) memory device into a system cache;
means for reading the static image frame content, during a static display refresh operation, from the system cache while the DRAM memory device is in a power-saving, self-refresh state; and
means for feeding the static image frame content to a mobile display.

10. The system of claim 9, further comprising means for turning off the DRAM memory device and a memory controller in the power-saving, self-refresh state while reading the static image frame content from the system cache.

11. The system of claim 1, wherein the means for prefetching the static image frame content from the DRAM memory device into the system cache comprises a means for sending a prefetch command to a system cache controller.

12. The system of claim 11, wherein the prefetch command comprises a variable burst length.

13. The system of claim 9, wherein the static image frame content is prefetched from the DRAM memory device into the system cache at a first burst length and the static image frame content is read from the system cache at a second burst length, wherein the first burst length is longer than the second burst length.

14. The system of claim 9, wherein the DRAM memory device comprises a double data rate (DDR) memory device and the static image frame content is prefetched from the DRAM memory device into the system cache at a double data rate (DDR) self-refresh rate.

15. The system of claim 9, wherein a portion of the static image frame content is prefetched from the DRAM memory device and loaded into and read from the system cache, and the remaining portion of the static image frame content is read from the DRAM memory device, and wherein the DRAM memory device is placed in the power-saving, self-refresh state while the portion of the static image frame content is read from the system cache.

16. A computer program embodied in a computer-readable medium and executed by a processor for reducing power consumption for static image display refresh, the computer program comprising:
logic configured to prefetch static image frame content from a dynamic random access memory (DRAM) memory device into a system cache;
logic configured to read, during a static display refresh operation, the static image frame content from the system cache while the DRAM memory device is in a power-saving, self-refresh state; and
logic configured to feed the static image frame content to a mobile display.

17. The computer program of claim 16, wherein the power-saving, self-refresh state comprises turning off the DRAM memory device and a memory controller.

18. The computer program of claim 16, wherein the logic configured to prefetch the static image frame content from the DRAM memory device into the system cache comprises logic configured to send a prefetch command to a system cache controller.

19. The computer program of claim 18, wherein the prefetch command comprises a variable burst length.

20. The computer program of claim 16, wherein the static image frame content is prefetched from the DRAM memory device into the system cache at a first burst length and the display processor reads the static image frame content from the system cache at a second burst length, wherein the first burst length is longer than the second burst length.

21. The computer program of claim 16, wherein the DRAM memory device comprises a double data rate (DDR) memory device and the static image frame content is prefetched from the DRAM memory device into the system cache at a double data rate (DDR) self-refresh rate associated with the DRAM memory device.

22. The computer program of claim 16, wherein a portion of the static image frame content is prefetched from the DRAM memory device and loaded into and read from the system cache, and the remaining portion of the static image frame content is read from the DRAM memory device, and wherein the DRAM memory device is placed in the power-saving, self-refresh state while the portion of the static image frame content is read from the system cache.

23. A system for reducing power consumption for static image display refresh, the system comprising:
a system on chip (SoC) comprising a system cache, a display processor, and a memory controller;
a volatile memory device residing off-chip and coupled to the memory controller; and
a power-saving static display refresh module comprising logic configured to:
prefetch static image frame content from the volatile memory device into a system cache;
during a static display refresh operation, read the static image frame content from the system cache while the volatile memory device is in a power-saving, self-refresh state; and
feed the static image frame content to a mobile display.

24. The system of claim 23, wherein the power-saving, self-refresh state comprises turning off the volatile memory device and a memory controller.

25. The system of claim 23, wherein the logic configured to prefetch the static image frame content from the volatile memory device into the system cache comprises logic configured to send a prefetch command to a system cache controller.

26. The system of claim 25, wherein the prefetch command comprises a variable burst length.

27. The system of claim 23, wherein the static image frame content is prefetched from the volatile memory device into the system cache at a first burst length and the static image frame content is read from the system cache at a second burst length, wherein the first burst length is longer than the second burst length.

28. The system of claim 23, wherein the volatile memory device comprises a double data rate (DDR) memory device and the static image frame content is prefetched at a DDR self-refresh rate.

29. The system of claim 23, wherein a portion of the static image frame content is prefetched from the volatile memory device and loaded into and read from the system cache, and the remaining portion of the static image frame content is read from the volatile memory device.

30. The system of claim 29, wherein the volatile memory device is placed in the power-saving, self-refresh state while the portion of the static image frame content is read from the system cache.
